(19) United States
(12) Patent Application Publication
(10) Pub. No.: US 2025/0033129 A1
(43) Pub. Date: Jan. 30, 2025

(54) METHOD AND DEVICE FOR OPTIMIZED WIRE ELECTRICAL DISCHARGE MACHINING

(71) Applicants: THERMOCOMPACT, Epagny Metz-Tessy (FR); GF Machining Solutions Services SA, Meyrin (CH)

(72) Inventors: Michel Ly, Annecy (FR); Bertrand Lavazais, Thoiry (FR)

(21) Appl. No.: 18/709,006

(22) PCT Filed: Dec. 9, 2022
(86) PCT No.: PCT/IB2022/061981

§ 371 Date: May 9, 2024

(30) Foreign Application Priority Data
Dec. 10, 2021 (EP) 21213881.2

(51) Int. Cl. B23H 7/20; B23H 7/10; B65H 75/18; G06K 19/07

(52) U.S. Cl. CPC B23H 7/20; B23H 7/10; B65H 75/182; G06K 19/0723

(57) ABSTRACT

Electrical discharge machining method on an electrical discharge machining machine using an electrical discharge machining wire packaged on a reel provided with an identification data medium (11) holding embedded identification data (ME) concerning said electrical discharge machining wire and embedded control data (CE) linked by a control function (F) to the embedded identification data (ME), —specific optimized machining parameters (PSP), and the control function (F), are previously stored in the electrical discharge machining machine, —the electrical discharge machining machine receives, from the identification data medium (11), read control data (CL) and read identification data (ML), —the electrical discharge machining machine searches to see if the read identification data (ML) and the read control data (CL) are linked by the control function (F), —if, and only if. the read identification data (ML) and the read control data (CL) are linked by said control function (F), the electrical discharge machining machine provokes or authorizes the machining as a function of said specific optimized machining parameters (PSP).

### TECHNICAL FIELD OF THE INVENTION

The present invention relates to the electrical discharge machining devices in which a continuous metal wire of small diameter, paid out from a reel on which it is packaged, passes in an electrical discharge machining machine through a machining zone filled with an appropriate dielectric. In the machining zone, a section of the wire is held by guides in proximity to a workpiece which is itself electrically conductive. An electrical current generator is connected between the wire and the workpiece, producing electrical arcs between the wire and the workpiece. The electrical arcs provoke the erosion of the wire and of the workpiece. To compensate for the erosion of the wire, the latter is permanently displaced in its longitudinal direction in the machining zone. In following the erosion produced on the workpiece, the wire is progressively displaced towards the workpiece by the electrical discharge machining machine, thus producing on the workpiece a cut-out by material removal.

The performance characteristics of the machining performed by electrical discharge machining depend on numerous parameters, and in particular:
machining parameters, determined by the electrical discharge machining machine, that can comprise the electrical power delivered by the electrical current generator the rate of longitudinal displacement of the wire, the longitudinal mechanical tension applied to the wire in the machining zone, the agitation of the dielectric in the machining zone, the functional offset, more generally referred to as simply “offset”, between the wire and the workpiece,
parameters concerning the structure or the quality of the wire itself, that can comprise the form of the wire, its length, its source, the stresses that it has undergone since it was manufactured, the electrical power that the wire can withstand without breaking during the machining, the structure and the composition of the wire itself, the mechanical tension that the wire can withstand without breaking, the mechanical characteristics of the wire which provide for a greater or lesser ease of introduction of the wire into the machining zone and into the guides of the electrical discharge machining machine at the start of machining,
parameters concerning the structure or the quality of the workpiece, that can comprise the form of the workpiece, the structure and the composition of the workpiece itself.

Based on these parameters, the removal of material on the workpiece can be more or less rapid, characterized by a machining speed or rate of penetration of the wire into the workpiece.

Based on these parameters, the machining performed can be more or less precise, characterized by a precision of the cut-out produced on the workpiece.

Or, based on these parameters, the machining performed can be characterized by a surface finish of the cut faces of the workpiece thus obtained.

Generally, during machining of a workpiece with a particular type of electrical discharge machining wire, the user is guided by the machine in the selection of the appropriate machining parameters to be used by the electrical discharge machining machine in order to obtain one or more particular machining performance characteristics. The sets of machining parameters are determined by the manufacturer of the electrical discharge machining machine, for a multitude of machining conditions. The expert user can in principle choose appropriate machining parameters or modify the machining parameters which are proposed to him or her by the machine in order to improve the machining performance levels.

However, to obtain a real optimization of the particular machining performance characteristics obtained with a particular type of electrical discharge machining wire, it appears necessary to first perform a very large number of machining tests by varying the machining parameters, the machining objectives, and the workpieces to obtain a specific set of optimized machining parameters. That constitutes a first difficulty.

Next, if a machining is performed by using the same set of specific optimized machining parameters but with an electrical discharge machining wire that is only slightly different, experience shows that the machining results obtained are disappointing, and are far from being optimized. That constitutes a second difficulty.

The result thereof is that, to obtain a real optimization of the particular machining performance characteristics, the electrical discharge machining machine should definitely associate, with an electrical discharge machining wire, the optimized machining parameters which are specific to it and which have given optimized results after numerous prior tests.

For that, on the one hand, the electrical discharge machining machine needs to know, with certainty and without the risk of error, the type of electrical discharge machining wire that the user has loaded for the machining, and also needs to include a storage of the set of specific optimized machining parameters for this type of electrical discharge machining wire.

When the user himself, or herself, introduces into the electrical discharge machining machine, identification data concerning the electrical discharge machining wire and the choice of the machining parameters, errors are possible, notably through erroneous input, or through erroneous reading, which does not make it possible to guarantee that the optimized machining result will be obtained.

In the document WO 2017/056045 A1, it was proposed to automate the introduction of the identification data concerning the electrical discharge machining wire into the electrical discharge machining machine. The electrical discharge machining wire is, for that, packaged on a reel which itself comprises a radio tag capable of communicating, generally at a frequency of 13.56 MHz, with a data reader device associated with the electrical discharge machining machine. The electrical discharge machining machine can then itself adapt the machining parameters by taking account of the identification data originating from the radio tag.

However, experience has shown that the electrical discharge machining machines generate electromagnetic disturbances which can hamper the correct reading of the identification data present on the radio tag. The 13.56 MHz frequency can be scrambled by some electrical discharge machining generators of the electrical discharge machining machine which uses the wire or of neighbouring electrical discharge machining machines, such that there can be reading and/or writing errors despite the communication protocols used.

The data transmission protocols can, indeed, detect errors between a transmitter and an electrical discharge machining machine. However, they cannot detect if an erroneous identification data has been written previously. Such an error can for example consist in an erroneous write due to an error in the software of an electrical discharge machining machine itself during a prior use of the reel, which is commonplace. Another example is a write error produced in handling (storage, removal from storage, weighing, etc.) of the reel prior to its installation on the electrical discharge machining machine.

It will be understood that an erroneous reading of the identification data concerning the electrical discharge machining wire, or the presence of erroneous identification data, can lead, through the application of inappropriate machining parameters, to the breakage of the electrical discharge machining wire, or to disappointing machining results.

### SUMMARY OF THE INVENTION

One issue set forth by the present invention is to avoid the drawbacks of the known electrical discharge machining methods and devices, and to avoid in particular the identification errors concerning the electrical discharge machining wires loaded on the electrical discharge machining machines for the machining tasks.

Another issue set forth by the invention is to guarantee that the most satisfactory possible machining will be obtained in the use of an electrical discharge machining wire on an electrical discharge machining machine. The aim is then to limit the consequences of a possible storage or reading error, that is to say to obtain an optimal machining result, whether or not the wire reel has been definitely identified.

Another objective of the invention is to ensure that a particular type of wire is used in combination with a particular technology, and vice versa, in order to obtain standardized machining results.

To this end, the invention aims on the one hand to automatically guarantee that an optimized machining will be obtained whenever a particular type of electrical discharge machining wire, one that therefore has a particular constitution and/or characteristics, can be definitely associated in the electrical discharge machining machine with machining parameters which are specific to it and which have given optimized results in prior tests.

Preferably, the aim of the invention is to optimise the machining with certainty, if necessary taking into account historical data on the use of the electrical discharge machining wire.

In addition, the invention can aim, on the other hand, to automatically guarantee that a machining with the least possible degradation will be obtained when the electrical discharge machining wire cannot be definitely associated in the electrical discharge machining machine with specific machining parameters which have given optimized results in numerous prior tests.

To achieve these objectives, and others, according to a first aspect, the invention proposes an electrical discharge machining method on an electrical discharge machining machine using an electrical discharge machining wire packaged on a reel with which there is associated, forming an assembly, an identification data medium in the form of a RFID radio tag data carrier in which is stored in digital form embedded identification data concerning said electrical discharge machining wire, wherein
(a) the electrical discharge machining machine receives, from the identification data medium, read identification data representative of the embedded identification data contained in the identification data medium,
(b) the electrical discharge machining machine adapts the machining parameters by taking account notably of the read identification data originating from the identification data medium of the reel used for the machining, and wherein:
   specific optimized machining parameters are previously determined by machining tests carried out with electrical discharge machining wires of the same type as that of said electrical discharge machining wire packed on the reel, for example by carrying out said tests with different machining parameters, and by choosing as specific optimised machining parameters those parameters which provided the best machining performance in said tests,
   said specific optimized machining parameters, and a control function, are previously stored in storage means of the electrical discharge machining machine,
   embedded control data are previously determined so as to be linked by the control function to the embedded identification data of the electrical discharge machining wire, and are held on the identification data medium;
before the step (b):
   the electrical discharge machining machine receives, from the identification data medium, read control data,
   the electrical discharge machining machine searches to see if the read identification data and the read control data are linked by the control function,
   if, and only if, the read identification data and the read control data are linked by said control function, the electrical discharge machining machine provokes or authorizes the machining according to said specific optimized machining parameters.

In the present description, and in the claims, the expression “associated” means that the reel and the identification data medium are distributed in such a way as to be able to be used jointly by the electrical discharge machining machine, thus forming an assembly. The user uses the reel to place it on the electrical discharge machining machine, and uses the identification data medium for it to be read by the electrical discharge machining machine. For example, the reel and the identification data medium can be packaged together: the identification data medium can be fixed (for example glued) onto a flange of the reel, or onto a pouch containing the reel, or fixed or placed in a container which contains the reel.

In an RFID tag, as in a computer or an electrical discharge machining machine controller, information such as numerical values, text data and mathematical functions are stored in the form of numbers, usually in a 2-digit code, and are stored in specific locations. Each piece of information or data can thus be interpreted as an integer ME. In this description and in the claims, the term “control function F” refers to any mathematical calculation that can be applied to this integer ME to uniquely generate another integer CE, which can then be used as control data.

Preferably, the electrical discharge machining method is, furthermore, such that:
standard machining parameters are previously determined by machining tests carried out with various electrical discharge machining wires, for example by carrying out said tests with different machining parameters, and by choosing as standard parameters those parameters which provided, on average for said various electrical discharge machining wires, satisfactory machining performance during said tests,
said standard machining parameters are previously stored in the storage means of the electrical discharge machining machine,
if the electrical discharge machining machine determines that the read identification data and the read control data are not linked by said control function, the electrical discharge machining machine provokes or authorizes the machining according to said standard machining parameters.

In all cases, it may be advantageous to provide:
in determining the embedded control data, for the control function to be applied to the embedded identification data concerning the electrical discharge machining wire,
after reception of the read control data, for the electrical discharge machining machine to apply the control function to the read identification data to deduce therefrom verification data, and for the electrical discharge machining machine to compare the read control data received from the identification data medium with said verification data,
if the verification data match the read control data, the electrical discharge machining machine considers that the read identification data and the read control data are linked by said control function.

Alternatively, it may be advantageous to provide:
in determining the embedded control data, for the control function to be applied to the embedded identification data concerning the electrical discharge machining wire,
after reception of the read control data, for the electrical discharge machining machine to apply the reciprocal function of the control function to the embedded control data to deduce therefrom verification data, and the electrical discharge machining machine to compare the read identification data received from the identification data medium with said verification data,
if the verification data match the read identification data, the electrical discharge machining machine considers that the read identification data and the read control data are linked by said control function.

The control function can advantageously be an encrypting private key encryption function.

The identification data medium is a radio tag in which the embedded identification data and the embedded control data are stored in digital form, and in which historical data on the use of the electrical discharge machining wire, collected during previous sequences of use of the wire conditioned on the reel, can be recorded.

According to a second aspect, the invention proposes an electrical discharge machining machine, suitable for implementing the above machining method, in which:
the electrical discharge machining machine forms a functional unit with a data reader device, capable of reading embedded identification data stored in digital form in an identification data medium in the form of a RFID radio tag forming an assembly with a reel on which the wire is packaged, and capable of transmitting the read identification data to the electrical discharge machining machine,
the data reader device is also capable of reading the embedded control data held by the identification data medium of the reel, and of transmitting them to the electrical discharge machining machine,
the electrical discharge machining machine comprises storage means, in which specific optimized machining parameters and a control function are stored,
the electrical discharge machining machine comprises electrical discharge machining wire recognition means, comprising computation means and a stored computer program comprising a recognition sequence capable of verifying whether the read identification data and the read control data are linked by said control function,
the electrical discharge machining machine comprises control means and a stored computer program comprising a control sequence capable of provoking or authorizing the machining according to said specific optimized machining parameters if, and only if, the read identification data and the read control data are linked by the control function.

According to a third aspect, the invention proposes a wire reel for electrical discharge machining, suitable for the implementation of the above machining method, with which there is associated, forming an assembly, an identification data medium in the form of a RFID radio tag, the data of which can be read by a data reader device associated with an electrical discharge machining machine, the identification data medium holding embedded identification data concerning the wire, in which the identification data medium also holds embedded control data which are linked to the embedded identification data by a control function. Said control function is a mathematical calculation that can be applied to said embedded identification data considered as an integer to uniquely generate said embedded control data.

Preferably, in the identification data medium, the control function is an encrypting private key encryption function.

The identification data medium is a radio tag in which the embedded identification data and the embedded control data are stored in digital form, and in which historical data on the use of the electrical discharge machining wire, collected during previous sequences of use of the wire conditioned on the reel, can be recorded.

According to a fourth aspect, the invention proposes a device suitable for the implementation of the electrical discharge machining method. Such a device comprises:
an electrical discharge machining machine,
an electrical discharge machining wire packaged on a reel,
an identification data medium in the form of a RFID radio tag, associated and forming an assembly with the reel, and accessible for the reading of data that it holds,
embedded identification data of said wire, held by the identification data medium,
a data reader device, forming a functional unit with the electrical discharge machining machine, capable of reading the embedded identification data held by the identification data medium of the reel, and capable of transmitting the read identification data to the electrical discharge machining machine, wherein:
embedded control data are also held on the identification data medium,
the data reader device is also capable of reading the embedded control data held by the identification data medium of the reel, and of transmitting the read control data to the electrical discharge machining machine,
the electrical discharge machining machine comprises storage means, in which a control function and specific optimized machining parameters are stored, said parameters being previously determined by machining tests carried out with electrical discharge machining wires of the same type as that of said electrical discharge machining wire packed on the reel, for example by carrying out said tests with different machining parameters, and by choosing as specific optimised machining parameters those parameters which provided the best machining performance in said tests,
the electrical discharge machining machine comprises electrical discharge machining wire recognition means, comprising computation means and a stored computer program comprising a recognition sequence capable of verifying whether the read identification data and the read control data are linked by said control function,
the electrical discharge machining machine comprises control means and a stored computer program comprising a control sequence capable of provoking or authorizing the machining according to said specific optimized machining parameters if, and only if, the read identification data and the read control data are linked by the control function.

Preferably, the electrical discharge machining device is such that:
standard machining parameters are previously determined by machining tests carried out with various electrical discharge machining wires, for example by carrying out said tests with different machining parameters, and by choosing as standard parameters those parameters which provided, on average for said various electrical discharge machining wires, satisfactory machining performance during said tests, and said parameters are also stored in the storage means of the electrical discharge machining machine,
if the read identification data and the read control data are not linked by said control function, the control sequence of the electrical discharge machining machine provokes or authorizes the machining according to said standard machining parameters.

In such an electrical discharge machining device, the identification data medium is a radio tag, in which the embedded identification data and the embedded control data are stored in digital form, the data reader device being a radio frequency communication device capable of communicating with the radio tag.

### BRIEF DESCRIPTION OF THE DRAWINGS

Other aims, features and advantages of the present invention will emerge from the following description of particular embodiments, given in conjunction with the attached figures, in which:

FIG. 1 is a schematic view of an electrical discharge machining machine in the process of machining a workpiece by means of a wire packaged on a reel according to an embodiment of the present invention;

FIG. 2 schematically illustrates an identification data medium of passive radio tag type according to a first embodiment of the present invention, communicating by radio frequency with a data reader device associated with or implemented in an electrical discharge machining machine;

FIG. 3 schematically illustrates an identification data medium of active or semi-active radio tag type according to a second embodiment of the present invention, communicating by radio frequency with a data reader device associated with or implemented in an electrical discharge machining machine.

### DESCRIPTION OF PREFERRED EMBODIMENTS

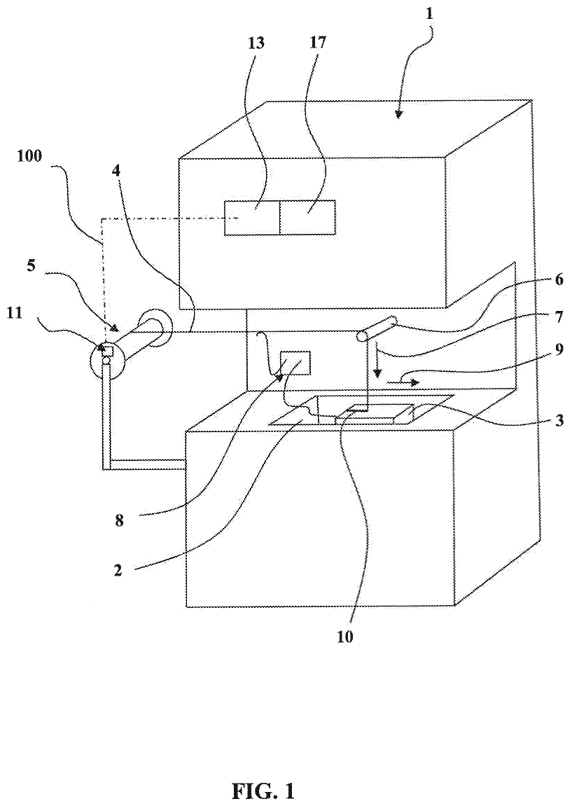

FIG. 1 is considered first of all, illustrating an electrical discharge machining device according to an embodiment of the present invention. The machining device generally comprises an electrical discharge machining machine 1 in which there is provided a machining zone 2 filled with an appropriate liquid dielectric. The machining zone 2 is shaped and structured to receive and hold a workpiece 3. An electrical discharge machining wire 4, packaged on a reel 5, is paid out from the reel 5 by passing over guides 6 of the electrical discharge machining machine 1 which hold it in position and which drive it longitudinally at an appropriate scrolling speed, as illustrated by the arrow 7. The electrical discharge machining wire 4 passes through the machining zone 2, in which it is held in proximity to the workpiece 3 according to an appropriate functional offset.

The electrical discharge machining machine 1 further comprises an electrical current generator 8, connected between the electrical discharge machining wire 4 and the workpiece 3, to produce electrical arcs between the electrical discharge machining wire 4 and the workpiece 3.

In operation, the electrical arcs provoke the erosion of the electrical discharge machining wire 4 and of the workpiece 3. The permanent longitudinal scrolling 7 of the electrical discharge machining wire 4 in the machining zone 2 makes it possible to avoid breakage of the electrical discharge machining wire 4 as a result of the erosion provoked by the electrical arcs on the wire. However, the erosion provoked on the workpiece 3 by the electrical arcs constitutes a removal of material which makes it possible, through progressive relative displacement of the electrical discharge machining wire 4 towards the workpiece 3, for example as illustrated by the arrow 9, to produce a cut-out 10 on the workpiece 3.

In the machining zone 2, the electrical discharge machining wire 4 must be kept taut by longitudinal mechanical traction provided by the guides 6, in order to maintain a rectilinear form and a stable and defined geometrical position, which guarantee a good geometry of the cut-out 10 made on the workpiece 3.

At the start of machining, the free end of the electrical discharge machining wire 4 must be introduced into the guides 6 and into the machining zone 2. Generally, the electrical discharge machining machine 1 comprises an operating sequence ensuring the automatic introduction of the wire. However, that requires the electrical discharge machining wire 4 to have satisfactory straightness and rigidity properties for the guiding of its free end to be able to be ensured when the guides 6 hold the wire only by intermediate sections away from the free end of the wire.

An electronic control circuit 17 drives the active members of the electrical discharge machining machine 1, so as to set the machining parameters such as the electrical power delivered by the electrical current generator 8, the rate of longitudinal displacement 7 of the wire, the longitudinal mechanical tension applied to the wire in the machining zone 2, the agitation of the dielectric in the machining zone 2, the functional offset between the wire 4 and the workpiece 3.

According to the invention, the machining device further comprises identification means allowing the automatic identification of the electrical discharge machining wire 4 packaged on the reel 5, and optimized control means suitable for, as a function of the electrical discharge machining wire 4 as identified, authorizing or provoking driving of the functional members of the electrical discharge machining machine 1 so as to allow an optimized machining of the workpiece 3 by this electrical discharge machining wire 4.

In the embodiment illustrated in FIGS. 1 to 3, the identification means comprise, in particular, an identification data medium 11, fixed onto a flange of the reel 5, holding on the one hand embedded identification data ME concerning the electrical discharge machining wire 4, and also holding on the other hand embedded control data CE which are linked by a control function F to the embedded identification data ME, as will be explained below.

The identification data medium 11 cooperates with a data reader device 13 functionally associated with the electrical discharge machining machine 1, via a wireless link 100 allowing communication between the identification data medium 11 and the data reader device 13.

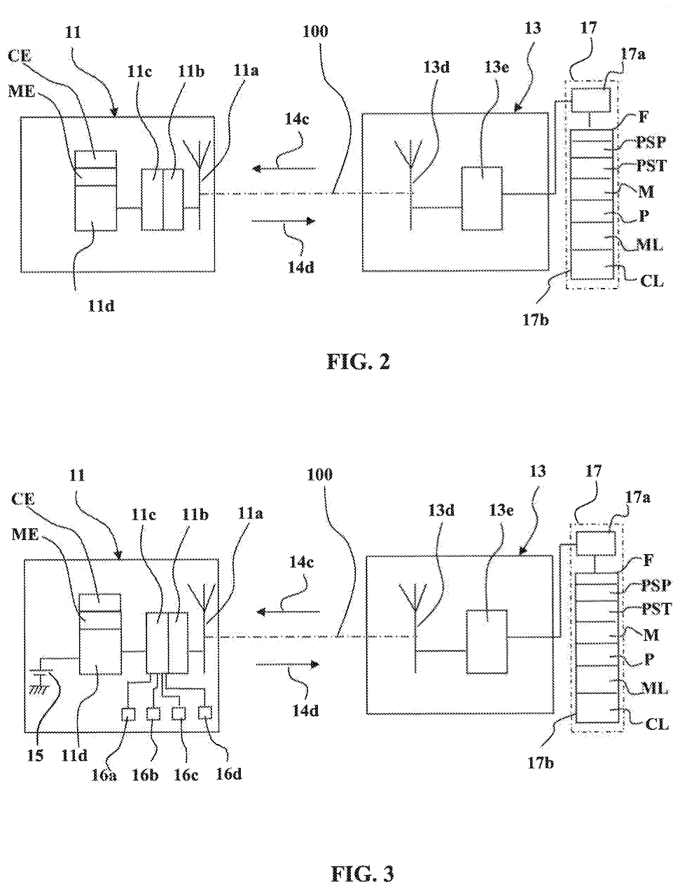

FIGS. 2 and 3 illustrate, by way of example, two embodiments of the identification device according to the invention.

In FIG. 2, the identification data medium 11 is a passive radio tag, comprising an antenna 11a, a power supply circuit 11b capable of taking a portion of the electrical energy picked up by the antenna 11a to generate a power supply voltage powering the other electronic circuits of the radio tag. An electronic processing circuit 11c receives the electronic request signals 14c picked up by the antenna 11a, communicates with a storage circuit 11d containing the embedded identification data ME and the embedded control data CE, and generates, as a function of the electronic request signals 14c, electronic response signals 14d that it transmits by the antenna 11a. For example, on reception of electronic request signals 14c requesting the communication of an identification, the passive radio tag 11 returns response signals 14d containing said embedded identification data ME and said embedded control data CE.

In this case, the data reader device 13 is an active device, a transmitter of radio frequencies which make it possible to remotely activate the radio tag 11. It comprises an antenna 13d and an electronic circuit 13e that makes it possible, on the one hand, to generate the request signals 14c to be transmitted by the antenna 13d to the radio tag 11, and, on the other hand, to process the response signals 14d originating from the radio tag 11 and picked up by the antenna 13d. The wireless link 100 is a radio link.

An exemplary embodiment of a radio tag and of a data reader device is described in the document U.S. Pat. No. 4,724,427.

In FIG. 3, the identification data medium 11 is an active or semi-active radio tag, in which there are again the main elements of the embodiment of FIG. 2, and in particular: an antenna 11a, a power supply circuit 11b, an electronic processing circuit 11c, a storage circuit 11d, having the same functions as those of the embodiment of FIG. 2. In FIG. 3, the identification data medium 11 further comprises an embedded electrical energy source 15, capable of supplying electrical energy, instead of or in addition to the electrical energy picked up by the antenna 11a, the electronic processing 11c and storage 11d circuits.

In this case, the identification data medium 11 further comprises embedded sensors, for example four embedded sensors 16a, 16b, 16c, 16d respectively supplying to the electronic processing circuit 11c signals that are an image of the acceleration undergone by the reel 5 bearing the wire 4 and the identification data medium 11, signals that are an image of the ambient temperature, signals that are an image of the ambient relative humidity, and signals that are an image of the weight of the reel 5.

The electronic processing circuit 11c is driven by an embedded computer program comprising a storage sequence for scanning and storing, in the storage circuit 11d, the signals produced by the embedded sensors 16a, 16b, 16c and 16d.

In this embodiment of FIG. 3, the data reader device 13 is also an active device transmitting radio frequencies which make it possible if necessary to remotely activate the radio tag 11, and comprising an antenna 13d and an electronic circuit 13e for generating, on the one hand, request signals 14c sent to the radio tag 11, and for processing, on the other hand, the reception signals 14d originating from the radio tag 11 and picked up by the antenna 13d. The wireless link 100 is a radio link.

The control circuit 17 of the electrical discharge machining machine 1 includes computation means 17a such as a processor, and storage means 17b.

The storage means 17b of the control circuit 17 contain sets of machining parameters, each set of machining parameters being intended to be used preferably for a particular type of machining with a particular type of electrical discharge machining wire. In particular, the storage means 17b of the control circuit 17 contain one or more sets of specific optimized machining parameters PSP which have each been determined after prior machining tests performed with one and the same type of electrical discharge machining machine 1 using one and the same type of electrical discharge machining wire M. In the storage means 17b of the control circuit 17, the sets of specific optimized machining parameters PSP are wholly or partly associated with identification data concerning the corresponding electrical discharge machining wire M.

The storage means 17b of the control circuit 17 also contain a computer program P which is implemented by the computation means 17a, notably making it possible to drive the active members of the electrical discharge machining machine 1 according to the selected sets of machining parameters, to perform a machining of a workpiece 3.

The computer program P of the control circuit 17 of the electrical discharge machining machine 1 comprises at least one sequence for downloading the embedded identification data ME and the embedded control data CE held by the identification data medium 11. As is well known in computer technology, the download sequence is programmed to recognise, by the addresses of their specific storage locations in the RFID radio tag, the identification data and the control data. The download sequence drives the data reader device 13 for it to generate request signals 14c and sends them to the identification data medium 11, which then returns to it a message 14d. The message 14d as received by the data reader device 13, after any possible electromagnetic disturbances, arrives at the control circuit 17 in the form of read identification data ML and in the form of read control data CL.

The computer program P of the control circuit 17 of the electrical discharge machining machine 1 comprises at least one sequence for adapting the machining parameters, taking into account in particular the read identification data ML and the read control data CL originating from the identification data medium 11 of the reel 5 used for the machining. In that way, the device according to the invention makes it possible to automate the adaptation of the electrical discharge machining parameters in the electrical discharge machining machine 1 as a function of the specific capabilities of the electrical discharge machining wire 4 used. For example, the adaptation sequence can modify or limit the parameters of mechanical tension of the electrical discharge machining wire 4 in the machining zone 2, of intensity of the electrical current flowing through the electrical discharge machining wire 4 in the machining zone 2, of rate of longitudinal displacement 7 of the electrical discharge machining wire 4 in the machining zone 2, of agitation of the dielectric in the machining zone 2, of transverse displacement 9 of the electrical discharge machining wire 4 in the machining zone 2, of maintaining of a functional offset between the electrical discharge machining wire 4 and the workpiece 3.

The downloading of the data relating to the electrical discharge machining wire 4 can be direct, by simple interrogation of the identification data medium 11 if the latter contains all of the necessary data.

Alternatively, the downloading of the data relating to the electrical discharge machining wire 4 can be partly indirect, the download sequence then comprising the downloading of at least the identity of the manufacturer of the wire 4 and the serial number of the reel 5 through interrogation of the identification data medium 11, and a sequence of automatic downloading of data relating to the reel 5 of wire 4 from a computer server of the manufacturer by interrogating the computer server of the manufacturer via the Internet by means of the information on the identity of the manufacturer of the wire 4 and the serial number of the reel 5.

According to the present invention, the computer program P of the control circuit 17 of the electrical discharge machining machine 1 comprises a particular sequence of identification of the electrical discharge machining wire 4, which proceeds with a more rigorous identification of the electrical discharge machining wire 4, not only by taking account of the read identification data ML as received from the identification data medium 11, but also by taking account of the control function F mentioned previously and by taking account of the read control data CL as received from the identification data medium 11.

The control function F is neither stored en clair, nor explained in the information held by the identification data medium 11. This control function F is used by the supplier of the electrical discharge machining wire 4 packaged on the reel 5 to generate the embedded control data CE from the embedded identification data ME. In that way, the embedded identification data ME and the embedded control data CE are linked to one another by said control function F.

By contrast, the control function F is itself stored in storage means 17b provided in the control circuit 17 of the electrical discharge machining machine 1.

On the identification data medium 11, the embedded identification data ME can notably be stored in the form of a series of binary signals (0 or 1), that is to say in the form of a natural integer number written in base 2. According to a first, particularly simple example, proposed to facilitate the understanding of the invention, a control function F can then consist of the NOT function, which inverts each binary signal of the embedded identification data ME: a binary 0 signal of the embedded identification data ME becomes a binary 1 signal in the embedded control data CE, while a binary 1 signal of the embedded identification data ME becomes a binary 0 signal in the embedded control data CE.

According to a second, somewhat more complex, example, a control function F can give the remainder C of the Euclidian division of the embedded identification data ME by an integer number K which itself consists of a private encryption key.

It is for example possible to choose the key K=19. By applying this function F to embedded identification data ME having the value 99, the embedded control data CE then have the value 4 because 99=19×5+4.

According to a third example, on the identification data medium 11, the embedded identification data ME can be coded according to the ASCII coding computer standard in a character string. The control function F can be the encryption function known as “aes-128-cbc”, by making use of a private encryption key K that can itself be encoded according to the ASCII coding computer standard. The use of this function can be easily implemented by computations performed on the website: https://encode-decode.com/aes-128-cbc-encrypt-online.

It is for example possible to choose the key K=“Thermocompact”. By applying this encryption function F to embedded identification data ME composed of the series “Fil Thermo SA 900 N/mm2 0.25 mm produit le 13/08/2020 sous le numéro 123456789”, the following embedded control data CE are obtained: “mUcNi+tUBbdONTrx8TmY76nBrtaqx5Cf1RZKdMbVMjf+POZK+aHmLFqE09FufsQ C0bGC89bG9D5pUdb7DY+euaftyLyZQJrExo5GOKGuDcI=”.

On receipt of the read identification data ML and of the read control data CL, the electrical discharge machining wire 4 identification sequence can apply the control function F to the read identification data ML, to thus generate verification data V, and can compare the verification data V and the read control data CL to one another. If they match, the identification sequence considers that the read identification data ML and the read control data CL are linked by said control function F, and that consequently the read identification data ML match the embedded identification data ME, and that the embedded identification data are correct.

Alternatively, on reception of the read identification data ML and of the read control data CL, the electrical discharge machining wire 4 identification sequence can apply the reciprocal function F⁻¹ of the control function F to the read control data CL to thus generate verification data W, and can compare the verification data W and the read identification data ML received from the identification data medium 11 to one another. If they match, the identification sequence considers that the read identification data ML and the read control data CL are linked by said control function F, and that consequently the read identification data ML match the embedded identification data ME, and that the embedded identification data are correct.

One benefit of the use of a private key encryption-based control function F is to further considerably reduce the risk of electrical discharge machining wire identification error. Indeed, in the third example above, if an error has been introduced into the embedded identification data ME, or if a transmission disturbance has introduced a slight modification between the embedded identification data ME and the read identification data ML, then the verification data V are very different from the read control data CL, which facilitates the recognition. In this particular case, if the sequence “SA” of the embedded identification data ME above has been modified into a sequence “SB” in the read identification data ML, by replacing only the letter “A” with the letter “B”, then the verification data V are: “u3hROePgvtGCCG3Ji2XFKyREIPfJSB6ZnF23gn7KrK4NqOD7WuH8t9QargS1dAi OG52mCHcoqPACtkE3vcHXspFJ8f3uP5aKTUnKGaFZeXg=”. V and CL are completely different. The specific optimized machining parameters PSP can therefore be applied with confidence when the verification data V match the embedded control data CE.

According to the present invention, the computer program P of the control circuit 17 of the electrical discharge machining machine 1 further comprises a particular authorization sequence, according to which the electrical discharge machining machine 1 authorizes or provokes the machining with the electrical discharge machining wire 4 by applying specific optimized machining parameters PSP if authorization conditions are met.

According to a first authorization condition, the identification sequence needs to have considered that the read identification data ML match the embedded identification data ME.

According to a second authorization condition, the read identification data ML must correspond to the essential identification data of one of the types of electrical discharge machining wire M itemized in the storage means 17b provided in the control circuit 17 of the electrical discharge machining machine 1.

When the first and second authorization conditions are fulfilled, the particular authorization sequence authorizes or provokes the machining with the electrical discharge machining wire 4 by applying the specific optimized machining parameters PSP previously stored in the storage means 17b provided in the control circuit 17.

With the identification of the electrical discharge machining wire 4 being made certain by virtue of the control means implemented above, the user can be certain of obtaining an optimized machining result whenever the electrical discharge machining machine 1 automatically provokes or authorizes the optimized machining.

There is another benefit in that the result of a machining is not too degraded when the electrical discharge machining machine 1 automatically assigns another set of machining parameters for the use of a given electrical discharge machining wire 4. Indeed, it has been found that the use of standard machining parameters leads to better machining results than the use of specific optimized machining parameters PSP with an electrical discharge machining wire 4 which is not provided for that.

As an example, with the wire “SA” mentioned above, it is possible to successfully use a variable functional offset in finishing, using a set of optimized parameters, whereas, with a wire “SB”, better finishing results are obtained with a fixed offset, that is to say with a set of standard machining parameters.

That is apparent in the measurement results hereinbelow:
by using the wire “SA” with specific optimized machining parameters PSP for this wire “SA”, the roughness Ra obtained in the direction of the wire is 0.16 microns, and the roughness in the direction of the cut is 0.17 microns, such that the workpiece is deemed conformal;
by using the wire “SB” with the same specific optimized machining parameters PSP of the wire “SA”, the roughness Ra in the direction of the wire is 0.17 microns whereas the roughness in the direction of the cut is 0.20 microns, such that the workpiece is deemed non-conformal;
by using the wire “SA” with standard machining parameters, the roughness Ra obtained in the direction of the wire is 0.19 microns, and the roughness in the direction of the cut is 0.20 microns, such that the workpiece is deemed conformal;
by using the wire “SB” with standard machining parameters, the roughness Ra obtained in the direction of the wire is 0.20 microns, and the roughness in the direction of the cut is 0.21 microns, such that the workpiece is deemed conformal.

In other words, if the wire “SB” is used with the specific optimized machining parameters PSP of the wire “SA”, a roughness Ra is obtained in the direction of the cut which is substantially higher than in the direction of the wire, which is visible to the eye and which is considered non-conformal.

By contrast, if the wire “SB” is used with standard machining parameters, the average roughness Ra is a little greater, but the roughness Ra in the direction of the cut is close to that in the direction of the wire, such that the workpiece is deemed visually conformal.

Thus, in case of uncertainty concerning the identification of an electrical discharge machining wire 4, it is preferable to employ sets of standard machining parameters PST.

For that, according to an advantageous embodiment, the storage means 17b of the control circuit 17 also contain one or more sets of standard machining parameters PST which have each been determined after prior machining tests performed with one and the same type of electrical discharge machining machine 1 by using several types of electrical discharge machining wire M and by obtaining a satisfactory average machining quality.

In this case, when at least one of the first and second authorization conditions is not fulfilled, the particular authorization sequence authorizes or provokes the machining with the electrical discharge machining wire 4 by applying the standard machining parameters PST previously stored in the storage means 17b provided in the control circuit 17. That way, the machining performed according to the standard machining parameters PST chosen automatically by the electrical discharge machining machine 1 is not optimized, but is again optimal, that is to say degraded as little as possible.

In addition, considering that the use of the specific optimized machining parameters PSP with an electrical discharge machining wire 4 whose type differs from that normally provided leads to a machining result which is generally worse than the machining result with standard machining parameters PST, the invention provides, according to an advantageous embodiment, for limiting or prohibiting the reading and the copying of the specific optimized machining parameter PSP files stored in the storage means 17b of the electrical discharge machining machine 1. To this end, the computer program P can contain a sequence controlling access to the specific optimized machining parameters PSP, this access control sequence possibly for example requiring the input of one or more secret codes. Cases of a user trying to manually force the use of specific optimized machining parameters PSP in the hope of producing an optimized machining with an electrical discharge machining wire 4 which is not provided for that, and then obtaining a degraded and defective machining, are thus avoided.

The present invention is not limited to the embodiments which have been explicitly described, but it includes miscellaneous variants and generalizations thereof that fall within the scope of the following claims.

1. An electrical discharge machining method on an electrical discharge machining machine (1) using an electrical discharge machining wire (4) packaged on a reel (5) forming an assembly with an identification data medium (11) in the form of a RFID radio tag data carrier in which is stored in digital form in specific locations identification data (ME) concerning said electrical discharge machining wire (4), wherein
(a) the electrical discharge machining machine (1) receives, from the identification data medium (11), read identification data (ML) representative of the embedded identification data (ME) contained in the identification data medium (11),
(b) the electrical discharge machining machine (1) adapts the machining parameters by taking account notably of the read identification data (ML) originating from the identification data medium (11) of the reel used for the machining,
characterized in that:
specific optimized machining parameters (PSP) are previously determined by machining tests carried out with electrical discharge machining wires of the same type as that of said electrical discharge machining wire (4) packed on the reel (5),
said specific optimized machining parameters (PSP), and a control function (F), are previously stored in specific locations of storage means (17b) of the electrical discharge machining machine (1),
standard machining parameters (PST) are previously determined by machining tests carried out with various electrical discharge machining wires,
said standard machining parameters (PST) are previously stored in specific locations in the storage means (17b) of the electrical discharge machining machine (1),
embedded control data (CE) are previously determined so as to be linked by the control function (F) to the embedded identification data (ME) of the electrical discharge machining wire (4), and are held in specific locations on the identification data medium (11),
and in that, before the step (b):
the electrical discharge machining machine (1) receives, from the identification data medium (11), read control data (CL),
the electrical discharge machining machine (1) searches to see if the read identification data (ML) and the read control data (CL) are linked by the control function (F),
if, and only if, the read identification data (ML) and the read control data (CL) are linked by said control function (F), the electrical discharge machining machine (1) provokes or authorizes the machining according to said specific optimized machining parameters (PSP),
if the electrical discharge machining machine (1) determines that the read identification data (ML) and the read control data (CL) are not linked by said control function (F), the electrical discharge machining machine (1) provokes or authorizes the machining according to said standard machining parameters (PST).

2. The electrical discharge machining method according to claim 1, characterized in that:
in determining the embedded control data (CE), the control function (F) is applied to the embedded identification data (ME) concerning the electrical discharge machining wire (4),
after reception of the read control data (CL), the electrical discharge machining machine (1) applies the function (F) to the read identification data (ML) to deduce therefrom verification data (V), and the electrical discharge machining machine (1) compares the read control data (CL) received from the identification data medium (11) with said verification data (V),
if the verification data (V) match the read control data (CL), the electrical discharge machining machine (1) considers that the read identification data (ML) and the read control data (CL) are linked by said control function (F).

3. The electrical discharge machining method according to claim 1, characterized in that:
in determining the embedded control data (CE), the control function (F) is applied to the embedded identification data (ME) concerning the electrical discharge machining wire (4),
after reception of the read control data (CL), the electrical discharge machining machine (1) applies the reciprocal function (F-1) of the control function (F) to the embedded control data (C) to deduce therefrom verification data (W), and the electrical discharge machining machine (1) compares the read identification data (ML) received from the identification data medium (11) with said verification data (W),
if the verification data (W) match the read identification data (ML), the electrical discharge machining machine (1) considers that the read identification data (ML) and the read control data (CL) are linked by said control function (F).

4. The electrical discharge machining method according to claim 1, characterized in that the control function (F) is an encrypting private key encryption function (K).

5. The electrical discharge machining method according to claim 1, wherein:
the electrical discharge machining machine (1) forms a functional unit with a data reader device (13), capable of reading embedded identification data (ME) stored in digital form in specific locations in an identification data medium (11) in the form of a RFID radio tag forming an assembly with a reel (5) on which the wire (1) is packaged, and capable of transmitting the read identification data (ML) to the electrical discharge machining machine (1),
the data reader device (13) is also capable of reading the embedded control data (CE) held in specific locations in the identification data medium (11) of the reel (5), and of transmitting them to the electrical discharge machining machine (1),
the electrical discharge machining machine (1) comprises storage means (17b), in which specific optimized machining parameters (PSP) and a control function (F) are stored in specific locations,
the electrical discharge machining machine (1) comprises electrical discharge machining wire recognition means, comprising computation means (17a) and a stored computer program (P) comprising a recognition sequence capable of verifying whether the read identification data (ML) and the read control data (CL) are linked by said control function (F),
the electrical discharge machining machine (1) comprises control means (17) and a stored computer program (P) comprising a control sequence capable of provoking or authorizing the machining according to said specific optimized machining parameters (PSP) if, and only if, the read identification data (ML) and the read control data (CL) are linked by the control function (F).

6. The electrical discharge machining method according to claim 1, forming an assembly with an identification data medium (11) in the form of a RFID radio tag, the data of which can be read by a data reader device (13) forming a functional unit with an electrical discharge machining machine (1), the identification data medium (11) holding in specific locations embedded identification data (ME) concerning the wire, characterized in that the identification data medium (11) also holds in specific locations embedded control data (CE) which are linked to the embedded identification data (ME) by a control function (F).

7. The electrical discharge machining method according to claim 6, characterized in that the control function (F) is an encrypting private key encryption function (K).

8. The electrical discharge machining method according to claim 6, characterized in that the identification data medium (11) is fixed onto a flange of the reel (5), or fixed onto a pouch containing the reel (5), or fixed or placed in a container which contains the reel (5).

9. An electrical discharge machining device (4), comprising:
an electrical discharge machining machine (1),
an electrical discharge machining wire (4) packaged on a reel (5),
an identification data medium (11) in the form of a RFID radio tag, forming an assembly with the reel (5) and accessible for the reading of data that it holds,
embedded identification data (ME) of said wire, held in specific locations by the identification data medium (11),
a data reader device (13), forming a functional unit with the electrical discharge machining machine (1), capable of reading the embedded identification data (ME) held by the identification data medium (11) of the reel (5), and capable of transmitting the read identification data (ML) to the electrical discharge machining machine (1),
characterized in that:
embedded control data (CE) are also held in specific locations on the identification data medium (11),
the data reader device (13) is also capable of reading the embedded control data (CE) held by the identification data medium (11) of the reel (5), and of transmitting them to the electrical discharge machining machine (1),
the electrical discharge machining machine (1) comprises storage means (17b), in which a control function (F) and specific optimized machining parameters (PSP) are stored in specific locations, said parameters being previously determined by machining tests carried out with electrical discharge machining wires of the same type as that of said electrical discharge machining wire (4) packed on the reel (5),
standard machining parameters (PST) are previously determined by machining tests carried out with various electrical discharge machining wires and are also stored in specific locations in the storage means (17b) of the electrical discharge machining machine (1),
the electrical discharge machining machine (1) comprises electrical discharge machining wire recognition means, comprising computation means (17a) and a stored computer program (P) comprising a recognition sequence capable of verifying whether the read identification data (ML) and the read control data (CL) are linked by said control function (F),
the electrical discharge machining machine (1) comprises control means (17) and a stored computer program (P) comprising a control sequence capable of provoking or authorizing the machining according to said specific optimized machining parameters (PSP) if, and only if, the read identification data (ML) and the read control data (CL) are linked by the control function (F),
if the read identification data (ML) and the read control data (CL) are not linked by said control function (F), the control sequence of the electrical discharge machining machine (1) provokes or authorizes the machining according to said standard machining parameters (PST).

10. The electrical discharge machining method according to claim 8, characterized in that the control function (F) is an encrypting private key encryption function (K).
